(19) United States
(12) Patent Application Publication
(10) Pub. No.: US 2016/0129720 A1
(43) Pub. Date: May 12, 2016

(54) SWIVEL NOTEBOOK PAD

(71) Applicant: Ronald KOEPPEL, Amityville, NY (US)

(72) Inventor: Ronald KOEPPEL, Amityville, NY (US)

(21) Appl. No.: 14/933,186

(22) Filed: Nov. 5, 2015

Related U.S. Application Data
(60) Provisional application No. 62/076,794, filed on Nov. 7, 2014.

(51) Int. Cl. B42D 3/06; B42D 1/00

(52) U.S. Cl. CPC B42D 3/06; B42D 1/00

(57) ABSTRACT

A rotatable notebook including at least one cover portion and a notepad having a stack of paper and a bottom rigid support portion. A fastening device connects the first rigid support portion of the notepad to one of the at least one notebook cover portion, the fastening device permitting rotation of the notepad relative to the at least one out cover portion. In one embodiment the notepad is rotatably fastened to the inner notebook cover portion by a grommet or snap secured to an extent sufficient to enable the rotatable 360 degree motion of the notepad relative to the book cover to which it is fastened.

### CROSS-REFERENCE TO RELATED APPLICATIONS

This application claims the benefit of U.S. Provisional Application No. 62/076,794 filed on Nov. 7, 2014, the entire contents of which is incorporated herein by reference.

### BACKGROUND

The present invention relates to a notebook, and more particularly, to a notebook having a pad swivel component for rotating a pad of paper.

### DESCRIPTION OF RELATED ART

School notebooks have been around for hundreds of years, typically in the form of wirebound books, gluebound books or casebound books. Some gluebound books and casebound books are popularly known as composition books. Composition books are used by millions of school students every year in elementary school, middle school, high school and even in colleges. In fact, it is even used in the workplace. The problem with composition books and many gluebound or casebound notebooks is that the paper inside is stitched tightly to a cover. More specifically, a fabric cover to hide the stitching is glued onto the front cover. As a student opens the notebook to write, it is frequently uncomfortable for a left handed person or a right handed person to write in the notebook as the paper and notebook lift up on the opposite side of the page on which a person is writing. As a result, handwriting tends to be sloppy as a result of trying to write, trying to be comfortable and dealing with a notebook that is somewhat closing in your hand. The solution has been to open the book, find the center of the book where the stitching is and literally open the notebook, forcefully bending back the notebook 180 degrees. Upon doing so, the spine with the stitching typically cracks or is weakened as a result of this stress placed on the notebook. When the stitching weakens and/or becomes loose, papers become separated from the notebook, and the notebook begins to fall apart. In the case of a gluebound notebook where there is no stitching, when the paper and cover lift up while writing, the situation becomes even worse. Since there is no stitching to hold the book together, if a user forceably opens the book all the way 180 degrees to try to flatten the book, typically the glue-binding breaks and pages fall out easily.

### SUMMARY

In one aspect, there is provided a rotating notebook with no spiral binding. The notebook includes an outer casing or binder cover (book cover) having an inside paper notepad. The paper notepad is fastened to a back cover of the notebook, without stitching. Particularly, a more rigid or stiffer back cover portion of the paper notepad of a more durable material, e.g., cardboard, is instead fastened onto the back cover of the outer casing or binder cover by a swivel fastener device such as a grommet that is configured to permit rotation of the pad about a swivel axis.

In another embodiment, the grommet can be replaced by a snap and washer combination to enable a user to snap in and out the different notepad.

The pad is thus wholly contained within the outer casing or binder cover and appears as a conventional student composition notebook. However, once the outer notebook cover is open, the pad is available for rotating movement about the swivel device to any desired degree.

In one aspect, paper notepad fastener to rotatably fasten the paper notepad to a back cover of the notebook, without stitching, is a circular grommet. There is optionally positioned washer type components on each grommet half to protect the pad and/or reduce friction of the rotating pad about the grommet fastener.

In one aspect, the Wireless Rotating Notebook is reusable in the sense that the paper notepad once used, is replaceable. That is, the pad can be removed, by snapping out the more rigid back cover portion of the paper notepad from the grommet and snapping a back cover portion of a new paper notepad back onto the grommet fastener to rotatably fasten the new paper notepad back to the back cover of the notebook.

According to one aspect of the present invention, a rotatable notebook is provided. The rotatable notebook comprises:

a notebook having two cover portions and a binding therebetween; and

a notepad having a stack of paper and a first rigid support portion,

a fastening device, connecting the first rigid support portion of the notepad to one of said two notebook cover portions, said fastening device permitting rotation of said notepad relative to said notebook cover portion.

The fastening device of the rotatable notebook permits 360 degree rotation of said notepad relative to said at least one of said cover portions.

In one embodiment, the notepad having a stack of paper is rotatably fastened to an inner surface of notebook cover portion.

In one embodiment, the fastening device includes a grommet, the grommet having first and second portions.

The rotatable notebook may further include a washer device interfaced between an under surface of a first grommet portion and a top surface of the notepad rigid support portion, and a further washer device interfaced between an under surface of a second grommet portion and an outer surface of the notebook cover portion.

### BRIEF DESCRIPTION OF THE DRAWINGS

The present invention and its embodiments will be more fully appreciated by reference to the following detailed description of illustrative embodiments in accordance with the present invention when taken in conjunction with the accompanying drawings.

The figures are illustrating:

FIG. 1 shows a swivel notebook having an outside cover;

FIG. 2 shows a side elevational view of the swivel notebook of FIG. 1

FIG. 3 shows an open view of the swivel notebook of FIG. 1 according to one embodiment;

FIG. 4 shows a portion of the open notebook view of FIG. 3 showing the notepad paper stack positioned above its back cover portion to reveal a notepad swivel fastener device in one embodiment;

FIG. 4A shows a detailed view of the swivel fastener 100 that includes a grommet or eyelet component;

FIG. 5A shows a detailed view of the swivel fastener operation that enables the notebook pad portion to rotate about the defined rotating axis to a first position relative to the outside notebook cover;

FIG. 5B shows the notebook pad portion 50 rotated a whole 90 degrees relative to the outside notebook cover, from an initial position shown in FIG. 4;

FIG. 5C shows the whole rotatable notebook 10 open with the notepad portion 50 rotated a whole 180 degrees relative to its position shown in FIG. 5B;

FIG. 6 shows one embodiment of a detailed method for fastening the bottom paper stack support back of the notepad onto a back cover portion of the notebook using swivel fastener; and

FIG. 7 shows a perspective, partial cut-away view of an assembled rotatable notebook 200.

### DETAILED DESCRIPTION

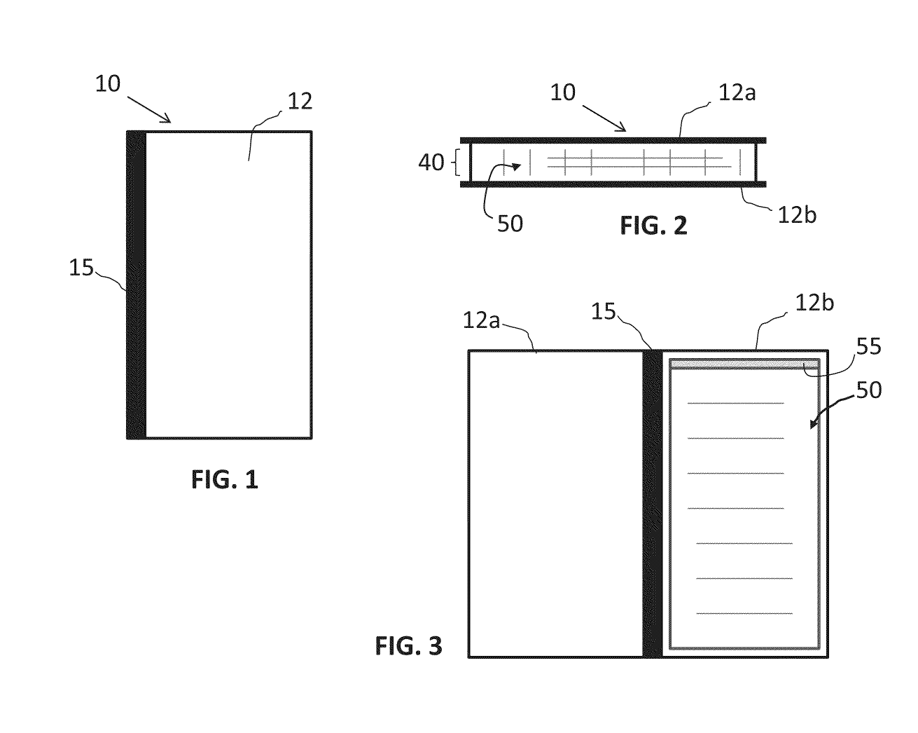

FIG. 1 shows a swivel notebook 10 having an outside cover 12 and a stitched binding portion 15. The notebook binding portion 15 may include a stitched, sewn, glued or casebound forming the notebook outside covers as conventionally known. That is, as shown in the side elevational view of FIG. 2 the swivel notebook 10 the binding portion 15 in a manner as conventionally known, functions to bind outside cover portions 12a and 12b together to form a compositional notebook. Rotatably fastened to a book cover 12a or 12b is a paper notepad 50 comprising a stack of paper 40 and a more rigid supportive back cover (not shown) on the bottom of the stack.

FIG. 3 shows the swivel notebook of FIG. 1 fully opened and depicting the outer book covers 12a, 12b and the paper notepad 50 rotatably fastened to the outside book cover portion 12b as explained in greater detail below.

The notepad 50 may include paper of any size, e.g., standard letter, half-letter, legal, ledger, tabloid, or any International (e.g., ISO) standard (including A4, B3, C4, etc.) or ANSI (American National Standards Institute) standard size, and the paper may be lined or not to accommodate writing usage, may be pre-cut with holes, may include perforations for removing, and may be of any grain, texture or thickness. As conventionally known, the pad paper may be glued or stitched (sewn) to a supportive back cover portion, typically of a material distinct from the writing surface (paper) material, and more durable such as cardboard (chipboard or greyboard) or polypropylene at the bottom of the paper stack 60 by a binding section 55 of the notepad 50 as shown in FIG. 3.

The size of the outer book cover portions 12a, 12b should be of a size and material suitable to fit the pad fastened therein such that the notebook 10 appears as any conventional whole composition notebook such as shown in the view of FIGS. 1 and 2.

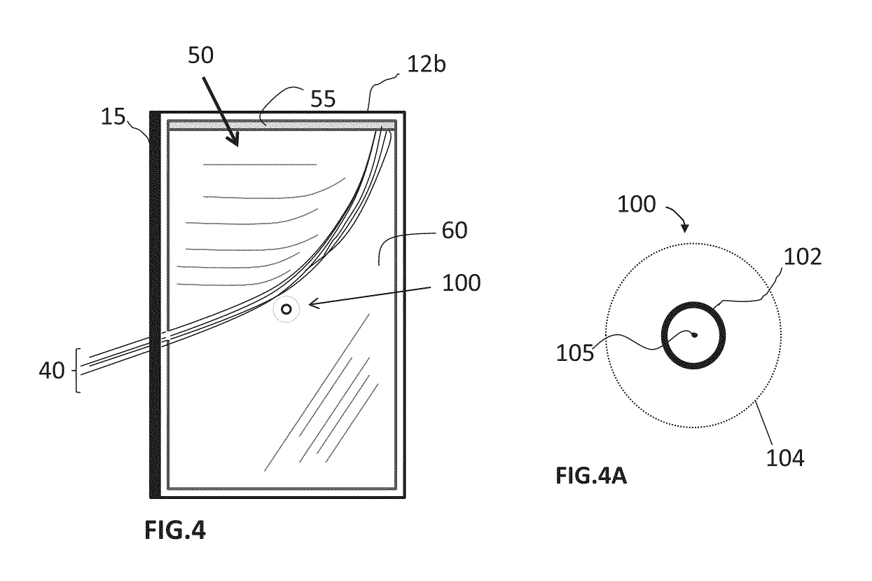

FIG. 4 shows a portion of the open notebook view of FIG. 3 showing the notepad 50 in an initial position relative to the notebook back cover 12b, and showing the paper stack 40 positioned above its back cover portion 60 to reveal a notepad swivel fastener device 100 that fastens a notepad supportive back cover portion 60 onto an inner (or inside) surface of the back cover portion 12b of the notebook in a manner to facilitate rotating of the whole notepad 50 itself relative to the notebook cover to which it is fastened. That is, the paper notepad is fastened to a back cover of the notebook, without stitching. Particularly, the more rigid or stiffer back cover portion 60 of the paper notepad stack 40 of a more durable material is fastened onto the inner surface of the cover or casing 12a or 12b of the notebook by a fastener device such as a grommet that is configured to permit rotation of the pad up to and including a full 360 degrees about a swivel axis.

FIG. 4A shows a more detailed view of the swivel fastener 100 that includes a grommet or eyelet component 102 and a washer component 104. In one embodiment, the combination of the grommet and washer components is configured to permit rotation of the notepad 50, relative to the notebook cover 12 to which it is fastened, about an imaginary rotate axis 105 through the plane of the paper which the figure is depicted on.

In an alternate embodiment, the grommet component may be replaced with a snap type fastener, which snap permits rotational motion of the pad and can be snap-closed or opened to permit installation and use of new or replacement notepads.

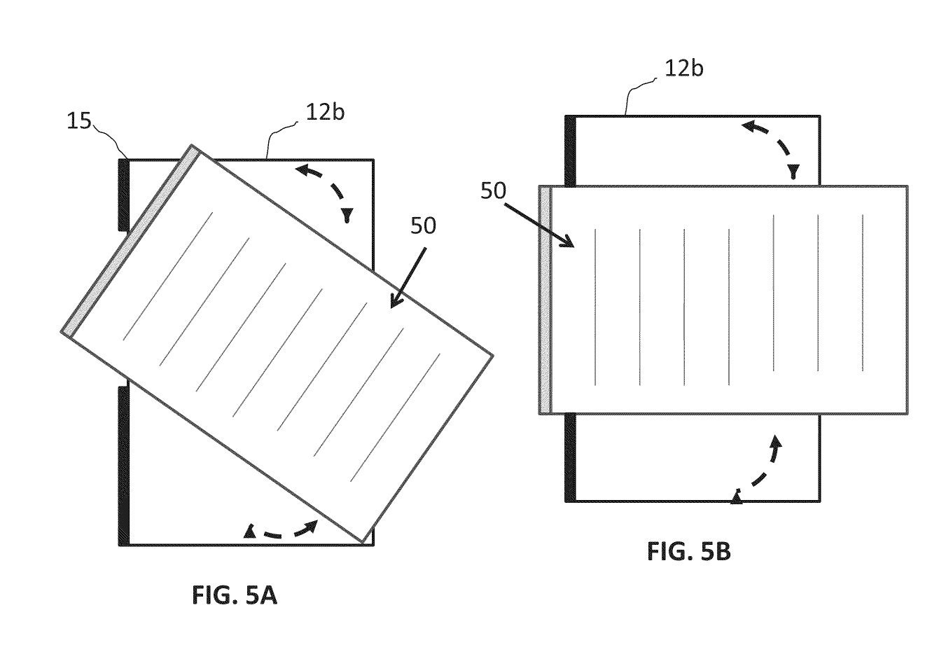

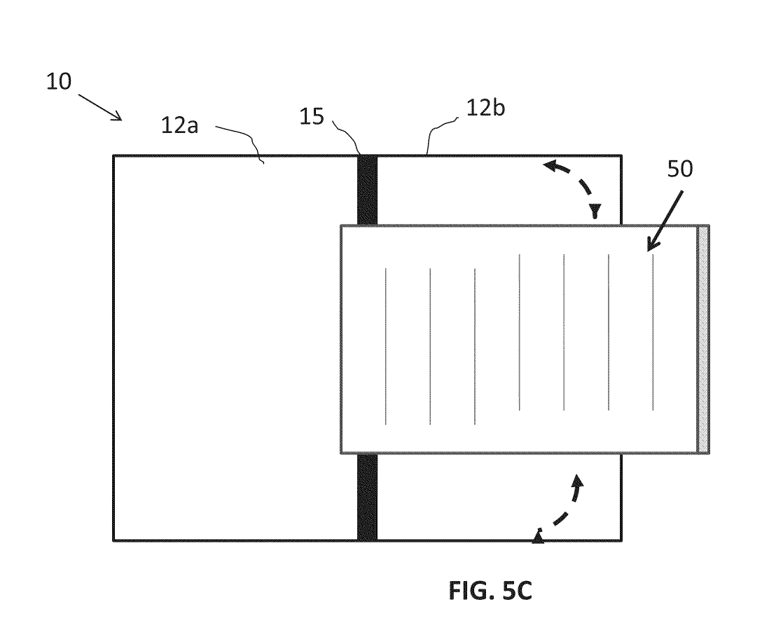

FIG. 5A shows a detailed view of the swivel fastener 100 operation that enables the notebook pad 50 to rotate about the defined rotating axis to a first position relative to the outside notebook cover 12b it is fastened to as indicated by the arrows. A further rotation, depicted in FIG. 5B shows the notebook pad portion 50 rotated a whole 90 degrees relative to the outside notebook cover 12b from its initial position shown in FIG. 4. A further rotation, depicted in FIG. 5C shows the whole rotatable notebook 10 open with the notepad portion 50 rotated a whole 180 degrees relative to its position shown in FIG. 5B.

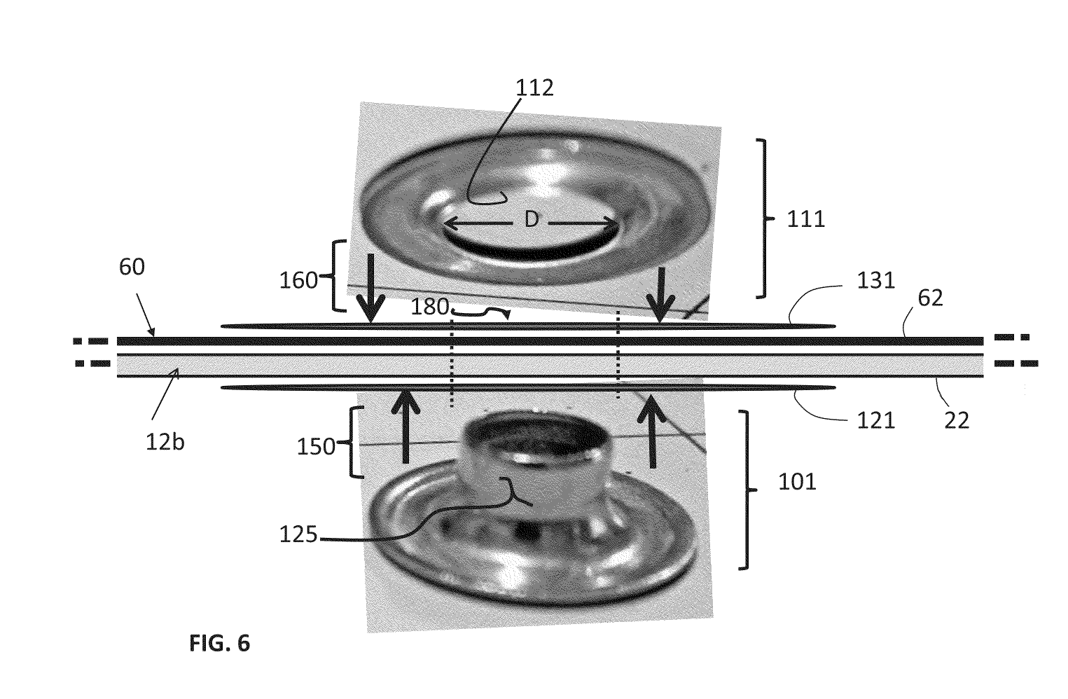

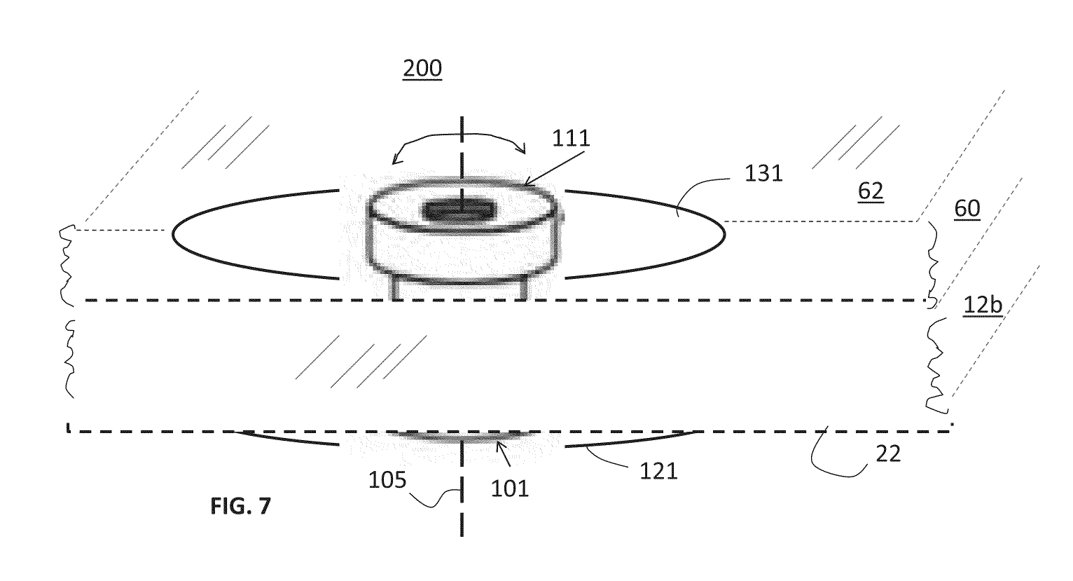

FIG. 6 shows a detailed method for fastening the paper stack support back 60 of the notepad 50 onto a back cover portion of the notebook 10 using swivel fastener 100. In one embodiment, swivel fastener device 100 includes a circular grommet which may be metal, rubber (for industrial purposes) or a plastic (snap-on type), and may come in a variety of colors/finishes. For purposes of discussion it is assumed that the grommet 100 is a metal material. The swivel fastener device 100 is comprised of two grommet pieces: a ring or circular shaped female portion 111 that is flared or collared having an inner diameter length “D”, and a ring or circular shaped male portion 101 that is flared or collared and that includes an extended portion 125 of a diameter commensurate with or slightly smaller than D.

In one embodiment, the paper stack support back 60 of the notepad 50 to be fastened and the back cover portion 12b of the notebook 10 are registered in alignment in the stacked relation shown in FIG. 6. In one embodiment, a hole 180 having a diameter commensurate with or slightly larger than an inner diameter D of the ring or circular shaped grommet portions 101, 111 may be first formed in both the registered paper stack support back 60 and the back cover portion 12b of the notebook 10 such as near the center of the both support back and back cover.

Using tools described in greater detail below, the male grommet portion 101 is inserted into the formed hole 180, e.g., in the direction depicted by arrows 150. The male grommet extended portion 125 is of a height that is sufficient to extend through both the back cover portion 12b and the paper stack support back 60 of the notepad to be fastened to penetrate therethrough in a manner so as to enable the engagement with a top female grommet portion 111. Then, simultaneously, or subsequently, once the male grommet portion 125 is fully extended through both the back cover portion 12b and the paper stack support back 60 of the notepad to be fastened, the female grommet portion 111 positioned in alignment with the male portion 125 is forced to engage the male grommet portion 125, e.g., in the direction as shown by arrows 160, thereby fastening the paper stack support back 60 of the notepad 50 to the back cover portion 12b of the notebook 10. It is understood that the fastening force used to engage the male and female grommet portions is such that rotation movement of the paper stack support back 60 of the notepad 50 relative to the back cover portion 12b of the notebook 10 is facilitated without undue effort of the user. Thus, the male and female grommet portions are not too tightly fastened to permit the relative rotational movement.

In the embodiment shown in FIG. 6, there is further fastened thin, disk-shaped washer pieces 121, 131 having diameters greater than outer ring diameter of the grommet portions 101, 112, on respective outer surfaces of the paper stack support back 60 of the notepad 50 to the back cover portion 12b of the notebook 10. That is, a washer piece 121 is aligned with the back cover portion 12b of the notebook 10 and is formed with the hole 180, and likewise, a washer piece 131 is aligned with the paper stack support back 60 and also formed with the hole 180 for fastening by the grommet fastener 100 onto respective support back and back cover portion to thereby distribute the load of the engaged male and female grommet fastener portions. In one embodiment, a first washer device is interfaced between an undersurface of a first grommet portion, e.g., the female portion 111, and a top surface 62 of the notepad rigid support portion 60, and a second washer device interfaced between an undersurface of a second grommet portion, e.g., the male portion 101, and an outer surface 22 of the notebook cover portion.

In one embodiment, the washers 121, 131 may be plastic, metal, or other materials designed to protect the respective surfaces 62, 22 of the respective support back 60 and back cover portion 12a about the grommet fastener 100 from degrading due to the relative rotational movement.

This allows for the paper notepad 50 to become mobile, where the user can rotate the paper of the notepad any way he or she wishes to a full 360 degrees to achieve the maximum comfort level to write as neatly as possible.

In a further embodiment, the grommet 100 and male and female portions 101, 111 thereof may be snap-fit together to releaseably fasten the notepad 50, notebook cover 12 either with or without washer components to render the notepad 50 releasable for portability, such that a user can replace a used notepad within the notebook with another. That is, a snap-fit grommet 200 may be employed having a male and female portions that may be separated, such as by prying or pulling apart, e.g., with a tool, or by hand. Once separated, the used paper stack notepad may be removed and a new paper stack notepad may be re-fastened to the outer cover in the manner as described herein.

FIG. 7 shows a perspective, partial cut-away view of an assembled rotatable notebook 200. The female grommet portion 111 and respective top washer 131 is shown exposed on the topside surface 62 of support back 60 to secure the secure paper stack support back 60 to the book cover portion 12b together with a fit sufficient to ensure relative rotational movement thereof about axis 105. The male grommet portion 101 is shown hidden as is the washer 121 on the underside surface 22 of notebook cover portion 12b.

In one embodiment, setting and fastening the male and female portions together may use conventional techniques, e.g., requiring use of a punch, e.g., a metal rod with a convex tip. A simple punch, can be struck with a hammer to set the grommet. There are also dedicated grommet presses with punch (grommet setter) and anvil to exactly match the size of the grommet, which may be used to more expediently manufacture the rotating notebook. Alternately, to install the grommet: a single grommet plier may be used besides a combination of a setter and anvil. A grommet inserting die (e.g., like the setter and anvil) and a hole cutter may be used.

Further, the processes for manufacture may be automated, i.e., punching the hole and use the grommet set and punch processes may be under programmed control.

In one embodiment, before installing the grommet 100, the grommet positioning is first determined which may include the centering of the grommet on the book cover and notepad support, e.g., using the grommet male portion 101.

Further, in one embodiment, a known grommet setting tool (not shown) may be implemented to first make an indent as to where the hole 180 is to be formed or a grommet hole cutter tool may be used to form the hole. The grommet male portion is inserted from underneath into the cut hole 180 so it pushes through. The grommet female portion is placed over the grommet portion 125 of the grommet sticking out through the hole 180. Using a sturdy surface, an anvil may be placed under the first grommet (male portion) and the setter is placed on top (female portion of grommet). With a hammer or mallet, or an automatically applied force, the setter is given one or more strong hits (such as with a hammer or mallet) to secure the bottom to the top by rolling the edge of the extended portion 125 of the male grommet portion 101 back over an inner edge 112 of the top female portion 111 with a force sufficient to “meld” the two pieces into one however permit relative rotational movement thereof.

It should be understood that the methodology described herein using a grommet and method such as shown in FIG. 6 is applicable to cover all lined and unlined paper, in notebooks of any size, journals of any size, sketchpads of any size, and whether the cover portions are in paper, plastic or other material and whether the books are wirebound, gluebound or casebound.

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A rotatable notebook comprising:
a notebook having two cover portions and a binding therebetween; and
a notepad having a stack of paper and a first rigid support portion,
a fastening device, connecting the first rigid support portion of the notepad to one of said two notebook cover portions, said fastening device permitting rotation of said notepad relative to said notebook cover portion.

2. The rotatable notebook of claim 1, wherein said fastening device permits 360 degree rotation of said notepad relative to said at least one out cover portion.

3. The rotatable notebook of claim 1, wherein said notepad having a stack of paper is rotatably fastened to an inner surface of notebook cover portion.

4. The rotatable notebook of claim 1, wherein the fastening device includes a grommet, the grommet having first and second portions.

5. The rotatable notebook of claim 1, further including a washer device interfaced between an under surface of a first grommet portion and a top surface of the notepad rigid support portion, and a further washer device interfaced between an under surface of a second grommet portion and an outer surface of the notebook cover portion.

6. The rotatable notebook of claim 1, wherein the fastening device includes a snap having first and second portions, said snap first and second portions being snap-opened or snap-closed to permit installation and use of new or replacement notepads.
